(19) United States
(12) Patent Application Publication
(10) Pub. No.: US 2023/0291649 A1
(43) Pub. Date: Sep. 14, 2023

(54) MANAGEMENT SYSTEM AND MANAGEMENT METHOD FOR INFORMATION APPARATUS

(71) Applicant: Hitachi, Ltd., Tokyo (JP)

(72) Inventors: Naoki KOBAYASHI, Tokyo (JP); Shinya TAKEUCHI, Tokyo (JP); Hiroshi HAYAKAWA, Tokyo (JP)

(21) Appl. No.: 17/888,365

(22) Filed: Aug. 15, 2022

(30) Foreign Application Priority Data
Mar. 8, 2022 (JP) 2022-035168

(51) Int. Cl. H04L 41/0853; H04L 41/0803

(52) U.S. Cl. CPC H04L 41/0853; H04L 41/0803

(57) ABSTRACT

A management system stores peripheral information apparatus management information for managing a configuration of a peripheral information apparatus on a network of a to-be-managed information apparatus. The peripheral information apparatus management information indicates an identifier of the peripheral information apparatus recognized in the network. The management system receives, from the to-be-managed information apparatus, current peripheral information apparatus configuration information indicating a configuration of the peripheral information apparatus in a current network of the to-be-managed information apparatus. The current peripheral information apparatus configuration information indicates an identifier of the peripheral information apparatus recognized in the current network. The management system compares the current peripheral information apparatus configuration information to the peripheral information apparatus management information, and determines, on the basis of a result of the comparison, whether to output an alert for the to-be-managed information apparatus.

### CLAIM OF PRIORITY

The present application claims priority from Japanese patent application JP2022-035168 filed on Mar. 8, 2022, the content of which is hereby incorporated by reference into this application.

### BACKGROUND

This disclosure relates to management of an information apparatus.

In recent years, SaaS management services that utilize the cloud have been in use for storage management due to the lack of need therefor to construct and manage a management server. Such management services have adopted a multi-tenant form in which storage units possessed by multiple organizations (clients) are managed in one location. US 2009/0151006 A1 discloses a technique by which devices to be managed are grouped for each owner, thereby facilitating registration to a management server as well as modification and deletion of registration information.

### SUMMARY

In a management system that manages information apparatuses of multiple organizations by linking the information apparatuses to the organizations that manage the same, it is necessary, when transferring management rights for an information apparatus managed by a given organization to another organization, for the management system to eliminate the link between the information apparatus and the organization from which the management rights are transferred. Failure to do so can allow the organization from which the management rights were transferred to continue to manage the information apparatus even after the management rights thereof were transferred. Thus, a technique by which the management rights for the information apparatus can be securely transferred is desired.

An aspect of the present invention is a management system for an information apparatus. The management system includes: one or more processors; and one or more storage devices. The one or more storage devices store peripheral information apparatus management information for managing a configuration of a peripheral information apparatus on a network of a to-be-managed information apparatus. The peripheral information apparatus management information indicates an identifier of the peripheral information apparatus recognized in the network. The one or more processors receive, from the to-be-managed information apparatus, current peripheral information apparatus configuration information indicating a configuration of the peripheral information apparatus in a current network of the to-be-managed information apparatus. The current peripheral information apparatus configuration information indicates an identifier of the peripheral information apparatus recognized in the current network. The one or more processors compare the current peripheral information apparatus configuration information to the peripheral information apparatus management information, and determine, on the basis of a result of the comparison, whether to output an alert for the to-be-managed information apparatus.

According to one aspect of the present invention, the management rights for the information apparatus can be securely transferred.

### BRIEF DESCRIPTION OF THE DRAWINGS

FIG. 1 schematically shows a configuration example of a computer system according to one embodiment of the present specification;

FIG. 2 shows a configuration example of the management system;

FIG. 3 shows an example of information included in the registered device management table;

FIG. 4 shows an example of information included in the peripheral information apparatus configuration management table;

FIG. 5 shows a configuration example of the information apparatuses managed by the management system;

FIG. 6 shows an example of information included in the MAC address management table;

FIG. 7 shows an example of information included in the port management table;

FIG. 8 shows an example of information included in the device configuration management table;

FIG. 9 shows a flowchart of an example of a peripheral information apparatus configuration information transmission process performed by the information apparatus;

FIG. 10 shows an example of a process by the management system;

FIG. 11 shows a flowchart of an example of the environmental difference detection process;

FIG. 12 shows a flowchart of an example of an alert output process performed by the information apparatus;

FIG. 13 shows an example in which the management rights of a storage device of a transfer origin organization are transferred to a transfer destination organization, and the storage device is transferred from the network of the transfer origin organization to the transfer destination organization; and

FIG. 14 shows an example in which the management rights of a storage device of a transfer origin organization are transferred to a transfer destination organization, and the storage device is transferred from the network of the transfer origin organization to the transfer destination organization.

### DETAILED DESCRIPTION OF EMBODIMENTS

Below, descriptions will be divided into multiple sections or embodiments as necessary for ease of explanation, but unless otherwise noted, the divided sections or embodiments are not unrelated to each other, and one section or embodiment is a modification example, a detail, or an addition, in part or in entirety, to another section or embodiment. Additionally, when referring to the number of elements or the like (including number, value, amount, range, etc.) below, unless otherwise noted or if the number is clearly limited to a specific value due to theoretical reasons, the number of elements is not limited to that specific value and may be more or less than the value.

This system may be a physical computer system (one or more physical computers) or may be a system constructed on a computer resource group (plurality of computer resources) such as a cloud platform. The computer system or computer resource group includes one or more interface devices (e.g., including communication devices and input/output devices), one or more storage devices (e.g., including a memory (main storage) and an auxiliary storage device), and one or more processors.

Where functions are realized by programs executed by a processor, a predetermined process is performed as appropriate using a storage device and/or an interface device or the like, and thus, the functions may be considered at least a portion of the processor. The processes described as being performed by the functions may be thought of as being performed by the processor or by a system having the processor. The program may be installed from a program source. The program source may be a programmed computer or a computer-readable storage medium (e.g., a computer-readable non-transitory storage medium), for example. The description of the functions constitutes merely one example, and a plurality of functions may be consolidated into one function or one function may be split into a plurality of functions.

Below, a management system for an information apparatus according to one embodiment of the present specification will be described. The management system manages information apparatuses of multiple organizations. The management system manages configuration information of peripheral information apparatuses of to-be-managed information apparatuses. The management system receives configuration information of current peripheral information apparatuses from to-be-managed information apparatuses transferred between organizations. The management system compares registration information for a peripheral apparatus configuration to configuration information of the current peripheral information apparatus to determine whether or not an alert is necessary. As a result, it is possible to raise an alert that the information apparatus and the organization managing the information apparatus continue to be erroneously linked on the management system.

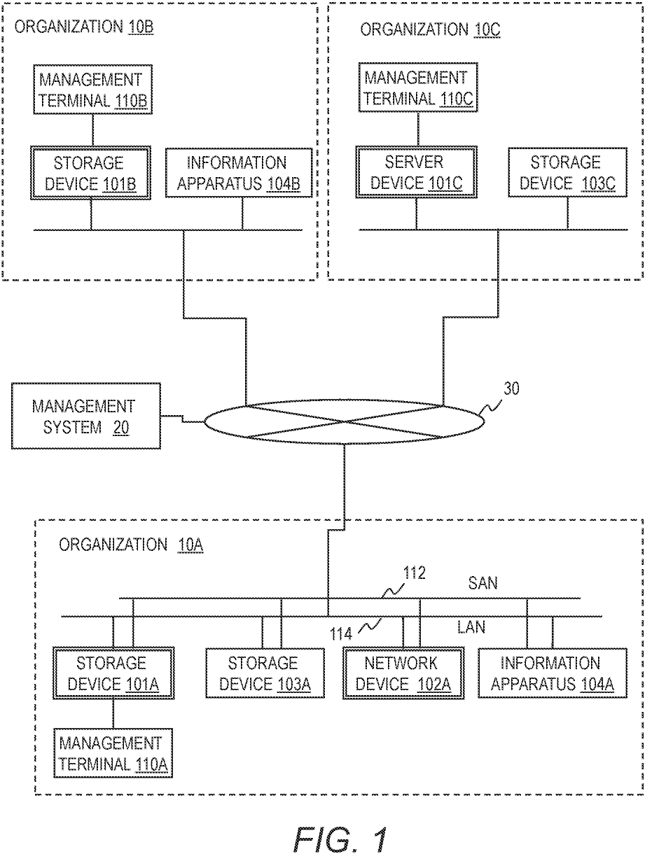

FIG. 1 schematically shows a configuration example of a computer system according to one embodiment of the present specification. FIG. 1 shows an example in which a management system manages an information apparatus managed by multiple organizations. The computer system includes information apparatuses of organizations 10A to 10C and a management system 20. The management system 20 and the network of the organizations 10A to 10C can communicate with each other via a wide area network 30.

The organizations 10A and 10B are client organizations such as various companies or data centers, for example, and the information apparatuses are located in physically separate locations. Examples of information apparatuses can include storage devices, server devices, network devices, IoT devices, and the like. The information apparatus configuration of the organizations shown in FIG. 1 is one example, and alternatively, a configuration may be adopted in which some of the information apparatuses are omitted and other information apparatuses are added.

The management system 20 provides a service for managing information apparatuses for multiple organizations including the organizations 10A to 10C. The service provided by the management system 20 may be a SaaS management system that utilizes the cloud, for example.

Each organization uses and manages a plurality of information apparatuses. Some or all of the information apparatuses used and managed by the organizations are registered and managed by the management system 20. In FIG. 1, the information apparatuses in double-lined rectangles are managed by the management system 20. The management system 20 provides a service to the manager of each organization for managing and operating information apparatuses registered in the management system 20.

For example, the organization 10A uses and manages a storage device 101A, a network device 102A, a storage device 103A, and other information apparatuses 104. These information apparatuses are connected to each other via a local area network (LAN) 114, and are connected to each other via a storage area network (SAN) 112. Among the information apparatuses of the organization 10A, the storage device 101A and the network device 102A are managed by the management system 20 while the other information apparatuses 103A and 104A are outside the scope of management by the management system.

The manager of the organization 10A can operate the storage device 101A and communicate with the management system 20 using a management terminal 110A. The management terminal 110A may be an interface device installed in the storage device 101A or may be a terminal connected to the management interface of the storage device 101A. The organization 10A can use another management terminal that is not shown in the drawing.

The organization 10B uses and manages a storage device 101B and an information apparatus 104B. These information apparatuses are connected to each other via a LAN or a SAN, for example. Among the information apparatuses of the organization 10B, the storage device 101B is managed by the management system 20 while the other information apparatus 104B is outside the scope of management by the management system.

The manager of the organization 10B can operate the storage device 101B and communicate with the management system 20 using a management terminal 110B. The management terminal 110B may be an interface device installed in the storage device 101B or may be a terminal connected to the management interface of the storage device 101B. The organization 10B can use another management terminal that is not shown in the drawing.

The organization 10C uses and manages a server device 101C and a storage device 103C. These information apparatuses are connected to each other via a LAN or a SAN, for example. Among the information apparatuses of the organization 10C, the server device 101C is managed by the management system 20 while the other information apparatus 103C is outside the scope of management by the management system.

The manager of the organization 10C can operate the server device 101C and communicate with the management system 20 using a management terminal 110C. The management terminal 110C may be a terminal connected to the management interface of the server device 101C. The organization 10B can use another management terminal that is not shown in the drawing.

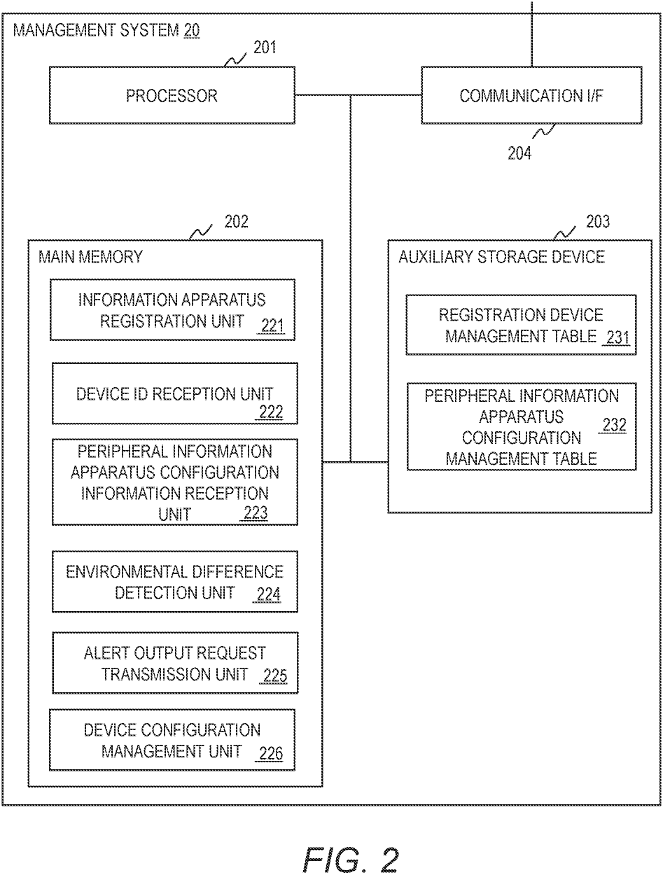

FIG. 2 shows a configuration example of the management system 20. The management system 20 includes a processor 201 that an arithmetic unit having arithmetic capabilities, and a main memory 202 that provides a volatile temporary storage region for storing programs to be executed by the processor 201 and data to be referenced and generated.

The management system 20 further includes a communication interface (I/F) 204 that performs data communication with other devices, and an auxiliary storage device 203 that provides a persistent information storage region using a hard disk drive (HDD), flash memory, or the like.

Also, the management system 20 can include an input device that receives operations from a user and an output device that provides output results from each process to a manager. Examples of the input device include a mouse or a keyboard. Examples of the output device include a monitor or a printer.

In FIG. 2, the main memory 202 stores an information apparatus registration unit 221, a device ID reception unit 222, a peripheral information apparatus configuration information reception unit 223, an environmental difference detection unit 224, an alert output request transmission unit 225, and a device configuration management unit 226. These are programs. The auxiliary storage device 203 stores a registered device management table 231 and a peripheral information apparatus configuration management table 232. Programs executed by the processor and data to be processed are loaded from the auxiliary storage device 203 to the main memory 202, for example.

The processor 201 executes programs stored in the memory 202, thereby operating as a functional unit that realizes functions defined by the programs. The processor 201 can, as a result of executing the programs, function as the information apparatus registration unit, the device ID reception unit, the peripheral information apparatus configuration information reception unit, the environmental difference detection unit, and the alert output request transmission unit, for example.

The device configuration management unit 226 periodically acquires the necessary configuration information of the information apparatus to be managed from the information apparatus, and issues a command such as a configuration modification to the information apparatus automatically or according to an instruction from the manager. Details of processes of other functional units will be described later.

The functions of the management system 20 may be divided into a plurality of devices or may be consolidated into one device. In this manner, the management system 20 that manages the information apparatuses can include one or more storage devices and one or more processors.

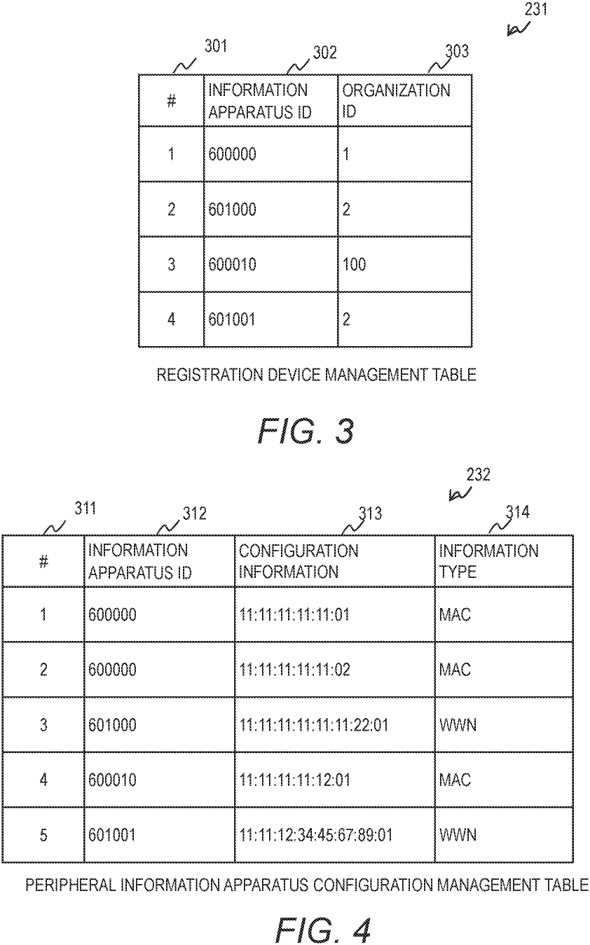

FIG. 3 shows an example of information included in the registered device management table 231. The registered device management table 231 stores information of the devices managed by the management system 20. For example, upon initially connecting to the to-be-managed information apparatus, the information apparatus registration unit 221 receives the ID thereof and stores the ID in the registered device management table 231.

The registered device management table 231 includes an entry number column 301, an information apparatus ID column 302, and an organization ID column 303. The entry number column 301 stores a number identifying each entry of the registered device management table 231. The information apparatus ID column 302 indicates the IDs of the information apparatuses managed by the management system 20. The information apparatus ID is the same as the device ID stored in the information apparatus to be described later. The organization ID column 303 indicates the IDs of the organizations to which the information apparatuses respectively belong. As described above, the registered device management table 231 associates the information apparatus with the organization using and managing the information apparatus and manages the information apparatus. The registered device management table 231 can include other information not shown in the drawing.

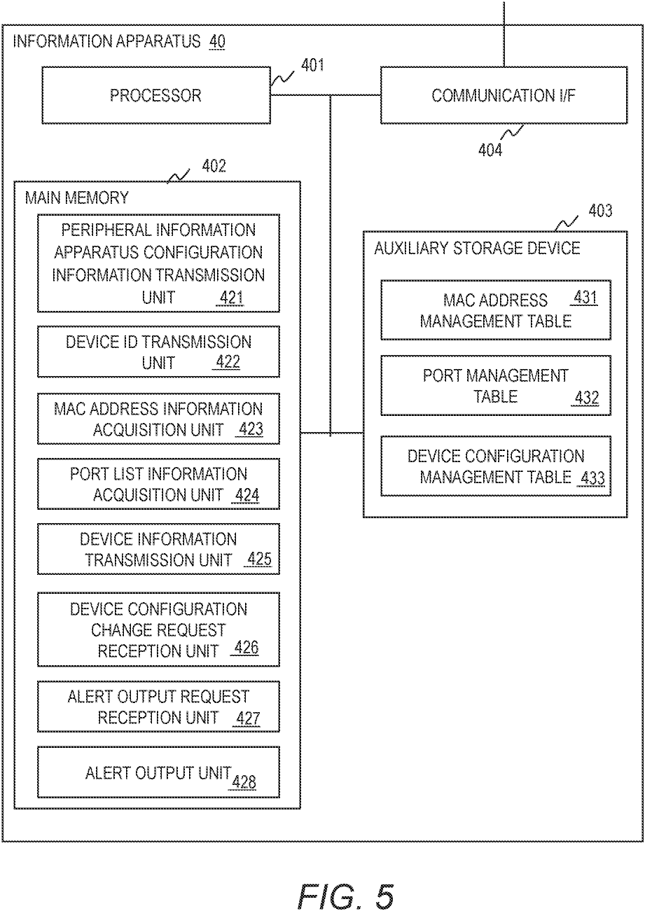

FIG. 4 shows an example of information included in the peripheral information apparatus configuration management table 232. The peripheral information apparatus configuration management table 232 manages configuration information of peripheral information apparatuses of to-be-managed information apparatuses (devices). The peripheral information apparatus of the one information apparatus is another information apparatus connected to the network within the organization. As will be described later, the information apparatus can acquire an identifier of the peripheral information apparatus via the network in the organization. The information apparatus registration unit 221 stores, in the peripheral information apparatus configuration management table 232, an identifier of the peripheral information apparatus from the to-be-managed information apparatus.

The configuration example of the peripheral information apparatus configuration management table 232 shown in FIG. 4 includes an entry number column 311, an information apparatus ID 312, a configuration information column 313, and an information type column 314. The peripheral information apparatus configuration management table 232 can include other information not shown in the drawing.

The entry number column 311 stores a number identifying each entry of the peripheral information apparatus configuration management table 232. The information apparatus ID column 312 indicates the IDs of the information apparatuses managed by the management system 20. The configuration information column 313 indicates identifiers of the respective peripheral information apparatuses of the information apparatuses indicated in the information apparatus ID column 312. The information type column 314 indicates the type of identifier indicated in the configuration information column 313.

In the example of FIG. 4, the identifier is a MAC address or a World Wide Name (WWN). These are examples of identifiers recognized in the network. If two identifiers are assigned to one information apparatus, then both identifiers are registered. In this manner, it is possible to make a more accurate determination by using a plurality of types of identifiers. There is no limit on the number of types of identifiers to be used.

The MAC addresses of two peripheral apparatuses of the information apparatus having the information apparatus ID “600000” are registered, for example, and the MAC addresses are “11:11:11:11:11:01” and “11:11:11:11:11:02.” The WWN of one peripheral apparatus of the information apparatus having the information apparatus ID “601000” is registered, and the WWN is “11:11:11:11:11:11:22:01.”

FIG. 5 shows a configuration example of the information apparatuses managed by the management system 20. The information apparatus 40 includes a processor 401 that an arithmetic unit having arithmetic capabilities, and a main memory 402 that provides a volatile temporary storage region for storing programs to be executed by the processor 401 and data to be referenced and generated.

The information apparatus 40 further includes a communication I/F 404 that performs data communication with other devices, and an auxiliary storage device 403 that provides a persistent information storage region using an HDD, flash memory, or the like.

In FIG. 5, the main memory 402 stores a peripheral information apparatus configuration information transmission unit 421, a device ID transmission unit 422, a MAC address information acquisition unit 423, a port list information acquisition unit 424, a device information transmission unit 425, a device configuration change request reception unit 426, an alert output request reception unit 457, and an alert output unit 428. These are programs.

The auxiliary storage device 403 stores a MAC address management table 431, a port management table 432, and a device configuration management table 433. Programs executed by the processor and data to be processed are loaded from the auxiliary storage device 403 to the main memory 402, for example.

The processor 401 executes programs stored in the memory 402, thereby operating as a functional unit that realizes functions defined by the programs. For example, as a result of executing the programs, the processor 401 can function as the peripheral information apparatus configuration information transmission unit, the device ID transmission unit, the MAC address information acquisition unit, the port list information acquisition unit, the device configuration information transmission unit, the device configuration change request reception unit, the alert output request reception unit, and the alert output unit.

The device information transmission unit 425 periodically transmits to the management system 20 configuration information, performance information, and the like of the information apparatus 40 managed by the management system 20. The device configuration change request reception unit 426 receives commands such as configuration changes from the management system 20 to the information apparatus 40. Details of other functional units will be described later.

As shown in FIG. 1, the information apparatus 40 includes a management terminal installed therein, or is connected to a management terminal via an interface. The management terminal can include an input device that receives operations from a user and an output device that provides output results from each process to a manager. Examples of the input device include a mouse or a keyboard. Examples of the output device include a monitor or a printer.

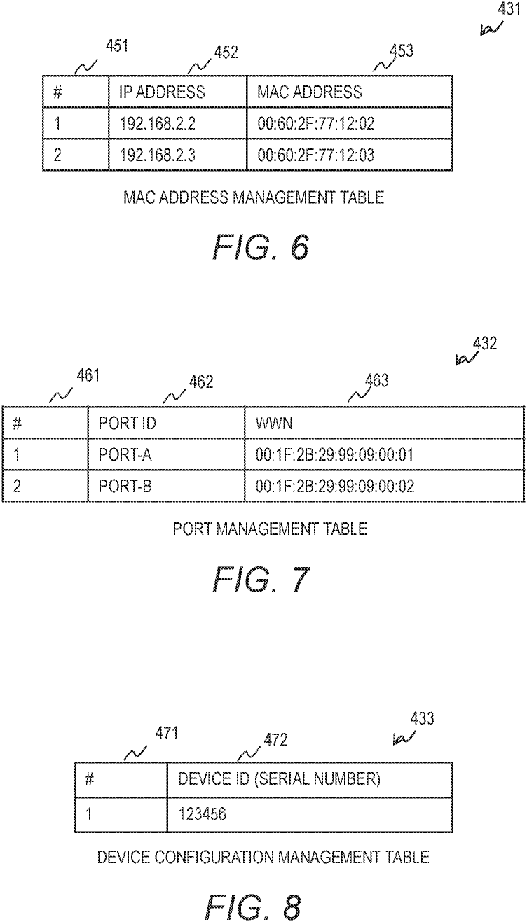

FIG. 6 shows an example of information included in the MAC address management table 431. The MAC address management table 431 manages the MAC addresses of the peripheral information apparatuses acquired by the information apparatus 40. As described above, the peripheral information apparatus can include apparatuses to be managed by the management system 20 as well as apparatuses outside of the scope of management by the management system. By including devices outside of the scope of management by the management system, it is possible to make a more accurate determination of errors in the management information. The MAC address can be acquired from an information apparatus connected to the LAN. The information apparatus 40 can collect the MAC addresses of information apparatuses connected to the LAN, or can acquire the MAC addresses of peripheral information apparatuses from network devices (e.g., routers) in the LAN, for example. The collection of MAC addresses is performed using a CLI or the like that can acquire MAC addresses using an ARP provided by the OS of the information apparatus, for example.

The configuration example of the MAC address management table 431 shown in FIG. 6 includes an entry number column 451, an IP address column 452, and a MAC address column 453. The entry number column 451 stores a number identifying each entry of the MAC address management table 431. The IP address column 452 indicates the IP addresses of the peripheral information apparatuses. The MAC address column 453 indicates the MAC addresses of the peripheral information apparatuses.

FIG. 7 shows an example of information included in the port management table 432. The port management table 432 manages the WWNs of the peripheral information apparatuses acquired by the information apparatus 40. If the information apparatus 40 is connected to a SAN, then the WWN of the peripheral information apparatus can be acquired. The WWN can be acquired from an information apparatus connected to the SAN, and it is possible to collect the WWN of the respective information apparatuses connected to the SAN or to acquire the WWN of the peripheral information apparatuses from a network device (e.g., a fiber channel switch). In order to acquire the WWN, an interface that can acquire the WWN such as a CLI of the storage device or the network device provided for each vendor is used.

The configuration example of the port management table 432 shown in FIG. 7 includes an entry number column 461, a port ID column 462, and a WWN column 463. The entry number column 461 stores a number identifying each entry of the port management table 432. The port ID column 462 indicates the IDs of ports of the information apparatuses 40. The WWN column 463 indicates WWNs of peripheral information apparatuses assigned to ports indicated by the port ID column 462.

FIG. 8 shows an example of information included in the device configuration management table 433. The device configuration management table 433 stores information pertaining to the configuration of the information apparatus 40. In the configuration example of FIG. 8, the device configuration management table 433 includes an entry number column 471 and a device ID column 472. The entry number column 471 stores a number identifying each entry of the device configuration management table 433.

The device ID column 472 indicates the device ID of the information apparatus 40, and as shown in FIGS. 3 and 4, the device ID is registered as the information apparatus ID in the management system 20. In the example shown in FIG. 8, a serial number is assigned as the device ID. The device ID is a unique ID assigned in order for the management system 20 to identify the device to be managed. As a result, the device to be managed is uniquely identified. In this example, the device ID differs from the identifier recognized on the network such as a MAC address or a WWN, and is unique to the management system. Any type of device ID can be used as long as the device ID can always identify the device to be managed.

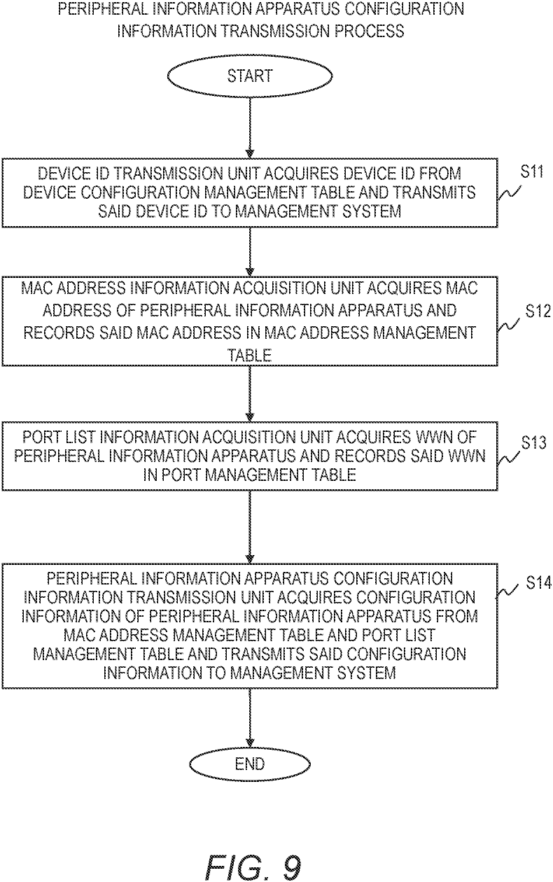

Next, an example of a process of the computer system shown in FIG. 1 will be described. First, an example of a process by the information apparatus 40 will be described. FIG. 9 shows a flowchart of an example of a peripheral information apparatus configuration information transmission process performed by the information apparatus 40. The information apparatus 40 acquires the configuration information of the peripheral information apparatuses via the network in the organization and transmits the configuration information to the management system 20.

Management rights for the information apparatus 40 can be transferred such that the information apparatus 40 is transferred from the network of one organization to the network of another organization. The information apparatus 40 automatically connects to the management system 20 when newly incorporated into the network of the organization to which the information apparatus is transferred. The information apparatus 40 acquires the peripheral information apparatus configuration information and transmits the configuration information to the management system 20 during initial connection to the management system 20. Also, the information apparatus 40 may periodically acquire the peripheral information apparatus configuration information and transmit the configuration information to the management system 20.

As shown in FIG. 9, the device ID transmission unit 422 of the information apparatus 40 acquires the device ID from the device configuration management table 433 and transmits the device ID to the management system 20 (S11). The management system 20 stores the device ID in the main memory 402, for example.

Next, the MAC address information acquisition unit 423 acquires the MAC address of the peripheral information apparatus and records the MAC address in the MAC address management table 431 (S12). The MAC address information acquisition unit 423 can acquire the MAC address from each of the peripheral information apparatuses or the network device via the LAN in the organization. If the MAC address of the peripheral information apparatus cannot be acquired such as when the information apparatus 40 is not connected to the LAN, then step S12 is omitted. The collection of MAC addresses is performed using a CLI or the like that can acquire MAC addresses using an ARP provided by the OS of the information apparatus, for example.

Next, a port list information acquisition unit 424 acquires the WWN of the peripheral information apparatus and records the WWN in the port management table 432 (S13). If the information apparatus 40 is connected to the SAN, the port list information acquisition unit 424 acquires the WWN of each port. The port list information acquisition unit 424 can acquire the WWN from each of the peripheral information apparatuses or the network device via the SAN in the organization. If the WWN of the peripheral information apparatus cannot be acquired such as when the information apparatus 40 is not connected to the SAN, then step S13 is omitted. In order to acquire the WWN, an interface that can acquire the WWN such as a CLI of the storage device or the network device provided for each vendor is used.

Next, the peripheral information apparatus configuration information transmission unit 421 acquires the configuration information of the peripheral information apparatus from the MAC address management table 431 and the port management table 432, and transmits the configuration information to the management system 20 (S14).

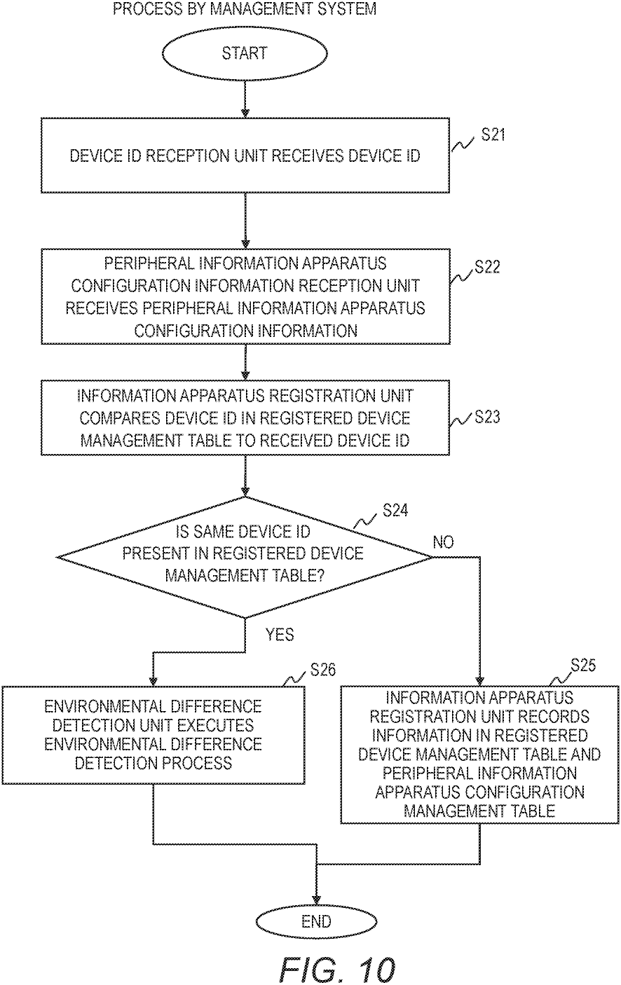

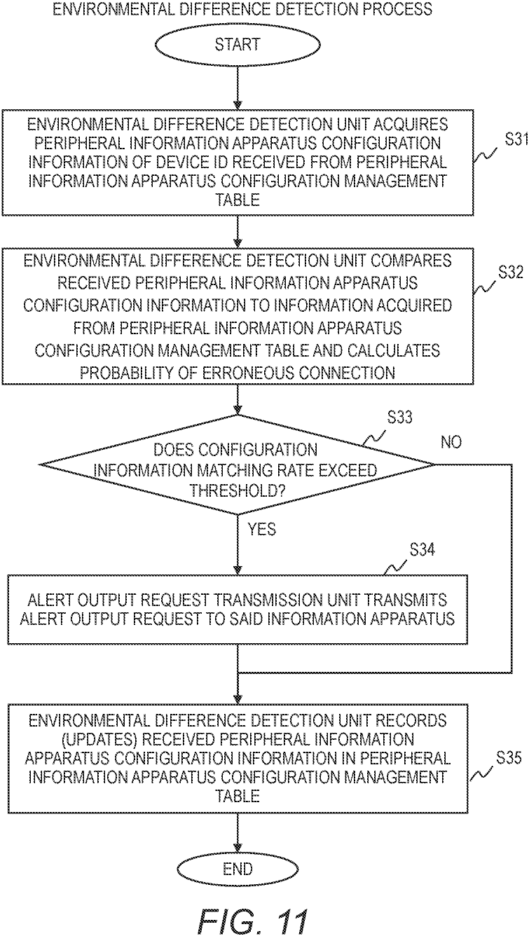

Next, an example of a process by the management system 20 will be described. FIG. 10 shows an example of a process by the management system 20. The device ID reception unit 22 of the management system 20 receives the device ID transmitted from the information apparatus 40 (S21). Additionally, the peripheral information apparatus configuration information reception unit 223 receives the peripheral information apparatus configuration information transmitted from the information apparatus 40 (S22).

Next, the information apparatus registration unit 221 refers to the registered device management table 231 and compares the device ID registered therein to the received device ID (S23). If the same device ID as the received device ID is not registered in the registered device management table 231 (S24: NO), then the information apparatus registration unit 221 newly registers information in the registered device management table 231 and the peripheral information apparatus configuration management table 232 (S25). Specifically, the device ID is registered in the registered device management table 231 and an identifier of the peripheral information apparatus is registered in the peripheral information apparatus configuration management table 232.

If the same device ID as the received device ID is registered in the registered device management table 231 (S24: YES), then the environmental difference detection unit 224 executes an environmental difference detection process (S26). Details of environmental difference detection process will be explained with reference to FIG. 11.

FIG. 11 shows a flowchart of an example of the environmental difference detection process. First, the environmental difference detection unit 224 acquires, from the peripheral information apparatus configuration management table 232, the peripheral information apparatus configuration information of the received device ID (S31). Specifically, the MAC address and the WWN associated with the device ID are acquired.

Next, the environmental difference detection unit 224 compares the received peripheral information apparatus configuration information to the configuration information acquired from the peripheral information apparatus configuration management table 232, and calculates the probability of erroneous connection of the information apparatus 40 (S32). The environmental difference detection unit 224 calculates the matching rate between the received configuration information and the configuration information acquired from the peripheral information apparatus configuration management table 232, and compares the matching rate to a threshold (S33). The matching rate is an example of a value indicating the degree of match between the received configuration information and the configuration information acquired from the peripheral information apparatus configuration management table 232.

Calculation of a matching rate X can be performed as follows.

$$\begin{matrix}\text{X} = \\ \left(\text{number of matching peripheral information apparatus identifiers}\right) / \\ \left(\text{number of registered peripheral information apparatus identifiers}\right) * \\ 100\end{matrix}$$

In the peripheral information apparatus configuration management table 232, if the number of peripheral information apparatus identifiers registered in association with the information apparatus 40 is 5 and the number of matches between the received peripheral apparatus identifiers and the number of registered peripheral information apparatus identifiers is 3, for example, then the matching rate X is 60%. The matching rate may alternatively be calculated by another method. The threshold is set in advance according to the organization or system, and may be 0%, for example.

If the matching rate is less than or equal to the threshold (S33: NO), then the alert output request transmission unit 225 transmits an alert output request to the information apparatus 40 (S34). If the matching rate exceeds the threshold (S33: YES), then step S34 is skipped. By determining whether or not to output an alert on the basis of the matching rate of the peripheral information apparatuses and the threshold in this manner, it is possible to perform suitable determination according to the organization.

Next, the environmental difference detection unit 224 registers the received peripheral information apparatus configuration information in the peripheral information apparatus configuration management table 232 (S35). Past peripheral information apparatus configuration information is already registered in the peripheral information apparatus configuration management table 232, and thus, the past information is updated with the received peripheral information apparatus configuration information.

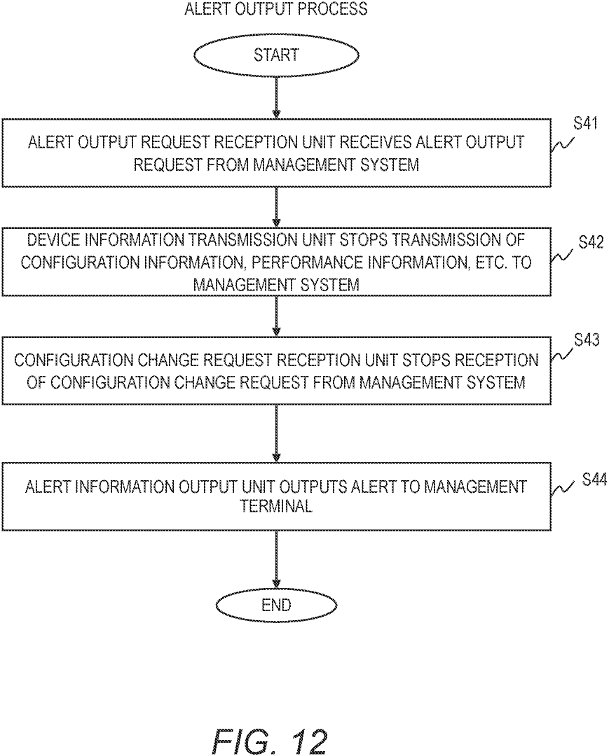

Next, the process of the information apparatus 40 that has received the alert output request from the management system 20 will be described. FIG. 12 shows a flowchart of an example of an alert output process performed by the information apparatus 40. The information apparatus 40 responds to the alert output request from the management system 20 and outputs an alert to the management terminal.

First, the alert output request reception unit 427 receives an alert output request from the management system (S41). In response thereto, the device information transmission unit 425 stops transmission to the management system 20 of the configuration information, performance information, and the like of the information apparatus 40 (S42). Additionally, the device configuration change request reception unit 426 stops receiving configuration change requests from the management system 20 (S43). The alert output unit 428 outputs an alert to the management terminal in response to the alert output request (S44).

As described above, according to the present embodiment, after management rights of the information apparatus are transferred, if the registration information of the management system 20 has not been suitably updated, then it is possible to alert the manager to whom the management rights were transferred. As a result, it is possible to prevent the transferred information apparatus from being operated by an organization from which the information apparatus was transferred.

As described above, by using unique identifiers such as MAC addresses or WWNs for peripheral information apparatuses on the network, it is possible for the information apparatus to acquire with ease the peripheral information apparatus configuration information. The identifiers of the peripheral information apparatuses may be a different type of identifier from the MAC address or the WWN. By transmitting an alert request to the transferred information apparatus, it is possible to alert the manager to whom the information apparatus is transferred even if the organization from which the information apparatus was transferred is unknown.

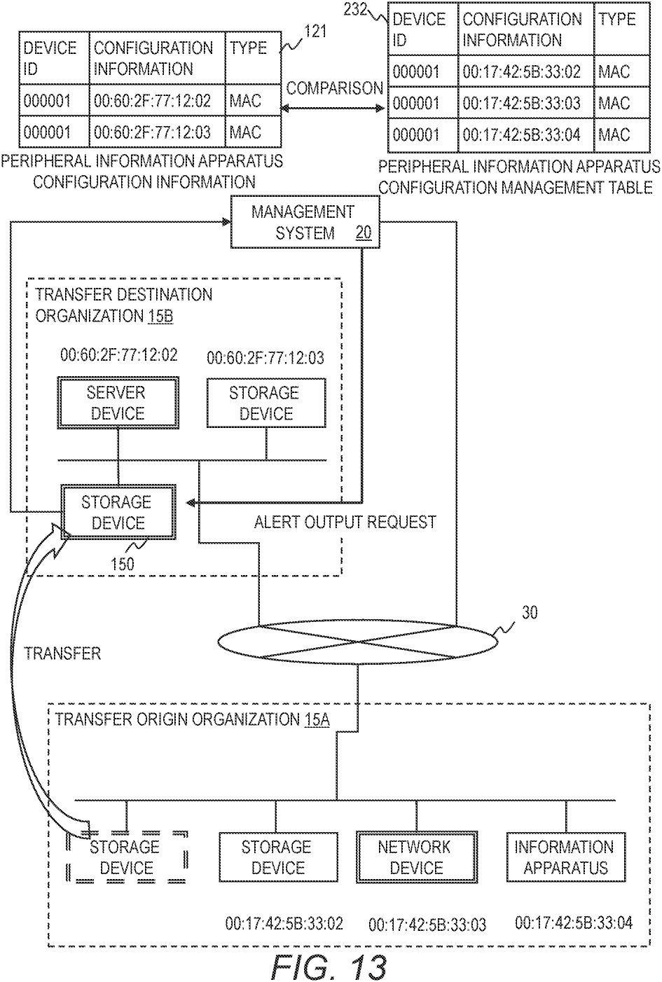

Next, examples of processes for transferring management rights of the information apparatus will be described. FIG. 13 shows an example in which the management rights of a storage device 150 of a transfer origin organization 15A are transferred to a transfer destination organization 15B, and the storage device 150 is transferred from the network of the transfer origin organization 15A to the transfer destination organization 15B. The device ID of the storage device 150 is “000001”.

The transfer origin organization 15A connects a plurality of information apparatuses to each other via a LAN. Thus, the peripheral information apparatus configuration management table 232 of the management system 20 stores the MAC address of the peripheral information apparatus in association with the device ID “000001” of the storage device 150. In the configuration example of FIG. 13, the MAC addresses of three peripheral information apparatuses in the transfer origin organization 15A are associated with the device ID “000001”. As described above, the information of the peripheral information apparatus configuration management table 232 is periodically updated.

The management system 20 acquires peripheral information apparatus configuration information 121 from the storage device 150 connected to the network of the transfer destination organization 15B. The transfer destination organization 15B connects a plurality of information apparatuses to each other via a LAN. Thus, the transmitted peripheral information apparatus configuration information 121 indicates the MAC addresses of the peripheral information apparatuses. In the configuration example of FIG. 13, the MAC addresses of two peripheral information apparatuses are indicated in the peripheral information apparatus configuration information 121.

The management system 20 compares the received peripheral information apparatus configuration information 121 to the stored peripheral information apparatus configuration information management table 232 and calculates the matching rate. In this example, all of the peripheral information apparatus identifiers (MAC addresses) differ from each other, and there are no matching peripheral information apparatus identifiers. The management system 20 transmits an alert output request to the storage device 150. As a result, it is possible to notify a manager at the transfer destination of an error in the management information of the transferred storage device 150.

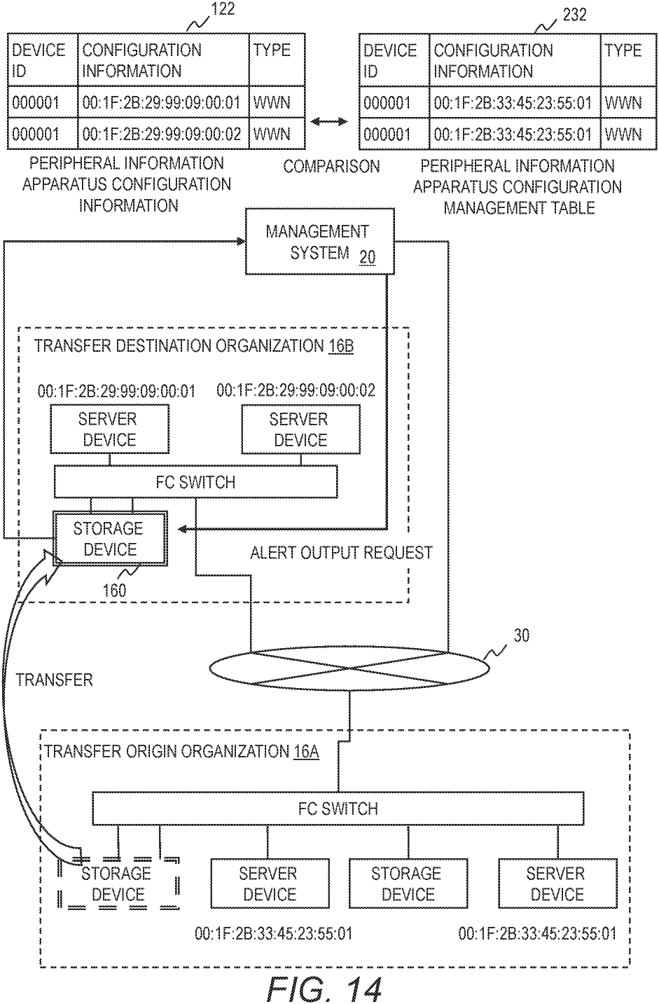

FIG. 14 shows an example in which the management rights of a storage device 160 of a transfer origin organization 16A are transferred to a transfer destination organization 16B, and the storage device 160 is transferred from the network of the transfer origin organization 16A to the transfer destination organization 16B. The device ID of the storage device 160 is “000001”.

The transfer origin organization 16A connects a plurality of information apparatuses to each other via a SAN (FC switch). Thus, the peripheral information apparatus configuration management table 232 of the management system 20 stores the WWN of the peripheral information apparatus in association with the device ID “000001” of the storage device 160. In the configuration example of FIG. 14, the WWNs of three peripheral information apparatuses in the transfer origin organization 16A are associated with the device ID “000001”. As described above, the information of the peripheral information apparatus configuration management table 232 is periodically updated.

The management system 20 acquires peripheral information apparatus configuration information 122 from the storage device 160 connected to the network of the transfer destination organization 16B. The transfer destination organization 16B connects a plurality of information apparatuses to each other via a SAN (FC switch). Thus, the transmitted peripheral information apparatus configuration information 122 indicates the WWNs of the peripheral information apparatuses. In the configuration example of FIG. 14, the WWNs of two peripheral information apparatuses are indicated in the peripheral information apparatus configuration information 122.

The management system 20 compares the received peripheral information apparatus configuration information 122 to the stored peripheral information apparatus configuration information management table 232 and calculates the matching rate. In this example, all of the peripheral information apparatus identifiers (WWNs) differ from each other, and there are no matching peripheral information apparatus identifiers. The management system 20 transmits an alert output request to the storage device 160. As a result, it is possible to notify a manager at the transfer destination of an error in the management information of the transferred storage device 160.

The present invention is not limited to the above-described embodiments but includes various modifications. The above-described embodiments are explained in details for better understanding of the present invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that almost of all components are actually interconnected.

What is claimed is:

1. A management system for an information apparatus, comprising:
one or more processors; and
one or more storage devices,
wherein the one or more storage devices store peripheral information apparatus management information for managing a configuration of a peripheral information apparatus on a network of a to-be-managed information apparatus,
wherein the peripheral information apparatus management information indicates an identifier of the peripheral information apparatus recognized in the network,
wherein the one or more processors receive, from the to-be-managed information apparatus, current peripheral information apparatus configuration information indicating a configuration of the peripheral information apparatus in a current network of the to-be-managed information apparatus,
wherein the current peripheral information apparatus configuration information indicates an identifier of the peripheral information apparatus recognized in the current network, and
wherein the one or more processors
compare the current peripheral information apparatus configuration information to the peripheral information apparatus management information, and
determine, on the basis of a result of the comparison, whether to output an alert for the to-be-managed information apparatus.

2. The management system according to claim 1,
wherein the peripheral information apparatus management information indicates a plurality of types of identifiers of the peripheral information apparatuses recognized in the network.

3. The management system according to claim 1,
wherein the one or more processors manage the to-be-managed information apparatus by an identifier of a different type from the identifiers of the peripheral information apparatus in the peripheral information apparatus management information and the current peripheral information apparatus configuration information.

4. The management system according to claim 1,
wherein the current peripheral information apparatus configuration information and the peripheral information apparatus management information indicate an information apparatus not managed by the management system.

5. The management system according to claim 1,
wherein the one or more processors request the to-be-managed information apparatus to output the alert.

6. The management system according to claim 1,
wherein the one or more processors compare a value indicating a matching rate of the identifiers between the current peripheral information apparatus configuration information and the peripheral information apparatus management information to determine whether to output the alert.

7. A management method for an information apparatus by a system,
wherein the system stores peripheral information apparatus management information for managing a configuration of a peripheral information apparatus on a network of a to-be-managed information apparatus,
wherein the peripheral information apparatus management information indicates an identifier of the peripheral information apparatus recognized in the network,
wherein, in the management method, the system
receives, from the to-be-managed information apparatus, current peripheral information apparatus configuration information indicating a configuration of the peripheral information apparatus in a current network of the to-be-managed information apparatus, and the current peripheral information apparatus configuration information indicates an identifier of the peripheral information apparatus recognized in the current network,
compares the current peripheral information apparatus configuration information to the peripheral information apparatus management information, and
determines, on the basis of a result of the comparison, whether to output an alert for the to-be-managed information apparatus.

8. The management method according to claim 7,
wherein the peripheral information apparatus management information indicates a plurality of types of identifiers of the peripheral information apparatuses recognized in the network.

9. The management method according to claim 7,
wherein the system manages the to-be-managed information apparatus by an identifier of a different type from the identifiers of the peripheral information apparatus in the peripheral information apparatus management information and the current peripheral information apparatus configuration information.

10. The management method according to claim 7,
wherein the current peripheral information apparatus configuration information and the peripheral information apparatus management information indicate an information apparatus not managed by the system.

11. The management method according to claim 7,
wherein the system requests the to-be-managed information apparatus to output the alert.

12. The management method according to claim 7,
wherein the system compares a value indicating a matching rate of the identifiers between the current peripheral information apparatus configuration information and the peripheral information apparatus management information to determine whether to output the alert.
